(19) United States
(12) Patent Application Publication
(10) Pub. No.: US 2006/0161957 A1
(43) Pub. Date: Jul. 20, 2006

(54) Method for providing digital broadcasting service in mobile communication terminal

(75) Inventors: Yong-Bok Lee, Suwon-si (KR); Sang-Hyuk Lee, Gunpo-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/195,924

(22) Filed: Aug. 3, 2005

(30) Foreign Application Priority Data
Jan. 18, 2005 (KR) 10-2005-0004677

(51) Int. Cl. H04N 7/173; H04N 7/16; H04M 1/00

(52) U.S. Cl. 725/62; 725/100; 725/134; 455/550.1

(57) ABSTRACT

A method for providing a digital broadcasting service in a mobile communication terminal connected to a server that stores digital broadcasting program related information through a data network. The method includes receiving a digital broadcast signal and outputting the received digital broadcast signal to a display unit; transmitting broadcasting information of the received digital broadcast signal to the server upon input of a predetermined key for requesting user-requested information, while outputting the received digital broadcast signal to the display unit; and receiving the user-requested information from the server and displaying the received user-requested information.

### PRIORITY

This application claims priority under 35 U.S.C. § 119 to an application entitled “Method for Providing Digital Broadcasting Service in Mobile Communication Terminal” filed in the Korean Intellectual Property Office on Jan. 18, 2005 and assigned Serial No. 2005-4677, the contents of which are incorporated herein by reference.

### BACKGROUND OF THE INVENTION

1. Field of the Invention

The present invention generally relates to a method for providing a digital broadcasting service in a mobile communication terminal, and in particular, to a method for providing a terrestrial digital broadcasting service in a mobile communication terminal.

2. Description of the Related Art

Generally, digital broadcasting indicates a broadcasting service that replaces conventional analog broadcasting by providing superior quality and services for both video and audio. Digital broadcasting is classified as satellite digital broadcasting or terrestrial digital broadcasting.

Satellite digital broadcasting is mainly intended for mobile services where individuals can view multichannel multimedia broadcasting anytime and anywhere, through a portable receiver (e.g., a mobile phone, a Personal Digital Assistant (PDA), or an automobile mounted receiver).

Terrestrial digital broadcasting is the concept of providing multimedia broadcasting on VHF channel 12, which is currently not utilized. The terrestrial digital broadcasting service can be supplied even as the user changes location. One broadcast channel can be split into three blocks, and it is expected that there will be 2 video channels or 1 video channel and 3 or 4 audio channels in each block. Such digital broadcasting will be mainly used in automobiles and be available free of charge.

With the recent development of digital broadcasting and mobile communication technologies, much attention is being drawn to a digital broadcasting service that allows a user to watch digital broadcasting even during the user's movement, and particularly, to a digital multimedia broadcasting (DMB) service using mobile communication terminals. DMB service allows a user to watch various multimedia broadcasting through multiple channels using a personal portable receiver or an automobile-use receiver mounted with an omni-directional reception antenna. DMB can provide service even as a user changes location.

Since digital broadcasting can simultaneously transmit multiple programs on a single physical channel, it has the advantage over analog broadcasting of providing a significant number of programs. Thus, there is an emerging need for common carriers (or digital broadcasting service providers) to provide program information to facilitate the user's ease of program selection. To meet the need, an electronic program guide (EPG) service has been provided.

The EPG service provides a user with information about the type of a current broadcasting program, the broadcasting channel (number) of the current broadcasting program, and the start and end times of scheduled broadcasting programs. Hereinafter, the EPG will be referred to as a digital broadcasting program guide data.

Thus, a mobile communication terminal receives the digital broadcasting program guide data that is transmitted from a digital broadcasting center at specific intervals and stores the received digital broadcasting program guide data in its internal memory or file system. A user can search the stored digital broadcasting program guide data to select a desired broadcasting program.

While watching terrestrial digital broadcasting (e.g., an entertainment program, a discussion program, or an Automatic Response System (ARS) program), using a mobile communication terminal, a user often participates in the corresponding program through a telephone connection. For example, when a discussion program collects thoughts or opinions of viewers through a telephone call-in connection, the program must provide a telephone contact number. Viewers listen for a telephone number that is provided by a host of the discussion program or watch for a telephone number that is temporarily provided as a caption on the screen. The viewer may then make a call to the telephone number (e.g., a representative telephone number of a broadcasting station for the discussion program or a representative telephone number of the discussion program), thereby participating in the discussion program.

However, in such a viewer-participation broadcasting program, a telephone number for viewer participation (e.g., a representative telephone number of a broadcasting station of the broadcasting program or a representative telephone number of the broadcasting program), is only temporarily provided. Viewers who miss the announcement of the contact telephone number to be called cannot participate in the broadcasting program unless they do their own search for the telephone number.

### SUMMARY OF THE INVENTION

It is, therefore, an object of the present invention to provide a method for providing a digital broadcasting service in a mobile communication terminal, which allows a user to easily participate in a digital broadcasting program, being watched, even when the user is not informed of a telephone number for viewer participation.

It is another object of the present invention to provide a method for improving user convenience by allowing a user to easily participate in a viewer-participation broadcasting program while watching it using a mobile communication terminal.

To achieve the above and other objects, there is provided a method for providing a digital broadcasting service in a mobile communication terminal connected to a server that stores digital broadcasting program related information through a data network. The method includes receiving a digital broadcast signal and outputting the received digital broadcast signal to a display unit; transmitting broadcasting information of the received digital broadcast signal to the server upon input of a predetermined key for requesting user-requested information while outputting the received digital broadcast signal to the display unit; and receiving the user-requested information from the server and displaying the received user-requested information.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a mobile communication terminal capable of receiving digital broadcasting according to a preferred embodiment of the present invention, including a digital broadcasting center, a common carrier server, and a base station;

FIG. 2 is a block diagram of a mobile communication terminal according to an embodiment of the present invention;

FIG. 3 is a flowchart illustrating a procedure in which a mobile communication terminal, according to an embodiment of the present invention, receives user-requested information from a common carrier server and provides a digital broadcasting service; and

FIGS. 4A and 4B illustrate a method for providing a digital broadcasting service in a mobile communication terminal according to an embodiment of the present invention.

### DETAILED DESCRIPTION OF THE PREFERRED EMBODIMENT

Preferred embodiments of the present invention will now be described in detail with reference to the annexed drawings. In the following description, a detailed description of known functions and configurations incorporated herein has been omitted for conciseness.

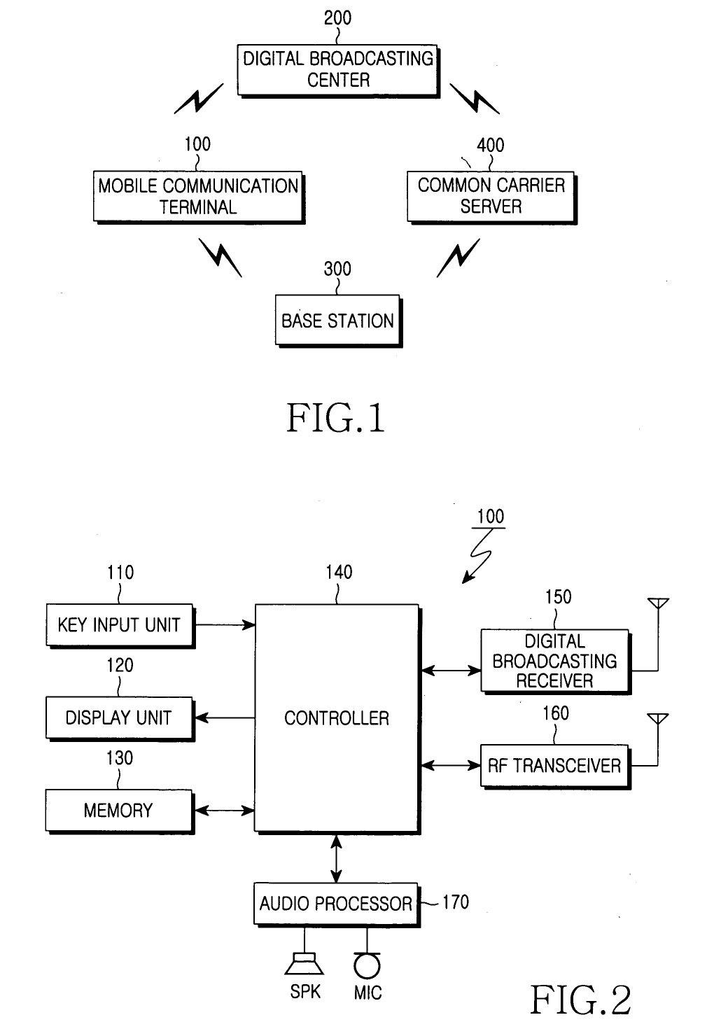

FIG. 1 illustrates a mobile communication terminal capable of receiving digital broadcasting according to a preferred embodiment of the present invention, a digital broadcasting center, a common carrier server, and a base station. A mobile communication terminal 100 capable of receiving digital broadcasting receives a digital broadcast signal transmitted from a digital broadcasting center 200 and outputs the received digital broadcast signal to a display unit (not shown), thereby providing a digital broadcasting service to a user. The mobile communication terminal 100 periodically receives digital broadcasting program guide information data from a digital broadcasting center 200 and stores the received digital broadcasting program guide information data.

The mobile communication terminal 100 requests user-requested information of a common carrier server 400 and displays the user-requested information transmitted from the common carrier server 400. The digital broadcasting center 200 provides digital broadcasting program related information to the common carrier server 400. A base station 300 transmits broadcasting information of a predetermined digital broadcasting program, transmitted from the mobile communication terminal 100 to request the user-requested information, to the common carrier server 400 through a data network. The base station 300 also transmits the user-requested information, transmitted from the common carrier server 400, to the mobile communication terminal 100.

Summarizing, the common carrier server 400 periodically updates and stores the digital broadcasting program related information; detects the user-requested information from digital broadcasting program related information (corresponding to the broadcasting information of the predetermined broadcasting program), transmitted from the mobile communication terminal 100; and transmits the detected user-requested information to the mobile communication terminal 100 through the base station 300. The common carrier server 400 may transmit the user-requested information to the mobile communication terminal 100 in the form of a short message or through wireless Internet.

The configuration of the mobile communication terminal 100 is described in detail with reference to FIG. 2, which is a block diagram of the mobile communication terminal 100 according to an embodiment of the present invention. The mobile communication terminal 100 includes a key input unit 110, a display unit 120, a memory 130, a controller 140, a digital broadcasting receiver 150, a radio frequency (RF) transceiver 160, and an audio processor 170.

The key input unit 110 has a key matrix structure (not shown) and includes character keys, number keys, and various function keys to output a key input signal, corresponding to a key input by a user, to the controller 140. According to an embodiment of the present invention, the key input unit 110 may further include an additional key that is preset for the mobile communication terminal 100 to transmit broadcasting information to the common carrier server 400 upon request for the user-request data (e.g., a representative telephone number of a broadcasting station of a corresponding program or a representative telephone number of the corresponding program).

The display unit 120 may be a liquid crystal display (LCD) and displays a digital broadcast signal and digital broadcasting program guide data received through the digital broadcasting receiver 150 under the control of the controller 140. After watching the displayed digital broadcasting program guide data, a user of the mobile communication terminal 100 can select a desired broadcasting program through the key input unit 110. The display unit 120 may output on-screen display (OSD) data according the size of a screen displayed through a video processor (not shown) having an OSD function.

The memory 130 stores various information required for controlling the operation of the mobile communication terminal 100 according to an embodiment of the present invention. The memory 130 also stores the digital broadcasting program guide data received through the digital broadcasting receiver 150. The memory 130 may store the user-requested information received from the base station 300.

The controller 140 controls overall operations of the mobile communication terminal 100 according to an embodiment of the present invention. Upon input of a predetermined key (e.g., a send key) for requesting user-requested information while a digital broadcast signal received from the digital broadcasting center 200 is being output to the display unit 120, the controller 140 detects broadcasting information of the received broadcast signal from the memory 130 and controls the RF transceiver 160 to transmit the detected broadcasting information to the common carrier server 400. Upon receipt of the user-requested information from the common carrier server 400, the controller 140 displays the received user-requested information on the display unit 120.

The digital broadcasting receiver 150 receives a digital broadcast signal from the digital broadcasting center 200 and outputs the received digital broadcast signal to the display unit 120. The digital broadcasting receiver 150 also receives digital broadcasting program guide data from the digital broadcasting center 200 and provides the same to the controller 140.

The RF transceiver 160 includes a high frequency processor, an intermediate frequency processor, and a baseband frequency processor. The RF transceiver 160 transmits and receives audio data, character data, video data, and control data under the control of the controller 140. The RF transceiver 160 also receives user-requested information transmitted from the common carrier server 400 through the base station 300 using a short message or wireless Internet and provides the received user-requested information to the controller 140.

The audio processor 170 may include a codec that includes a data codec for processing packet data and an audio codec for processing audio signals, like voice. The audio processor 170 modulates an electric signal input from a microphone to convert the modulated electric signal into audio data and demodulates encoded audio data input from the RF transceiver 160 or the digital broadcasting receiver 150 into an electric signal to output the electric signal to a speaker. In addition, it is preferable that the audio processor 170 includes a coder/decoder (codec) for converting a digital audio signal received from the RF transceiver 160 or the digital broadcasting receiver 150 into an analog audio signal and reproducing the analog signal or converting an analog audio signal generated from a microphone into a digital audio signal. The codec includes a data codec for processing packet data and an audio codec for processing audio signals, like voice. The codec may be separately provided or included in the controller 140.

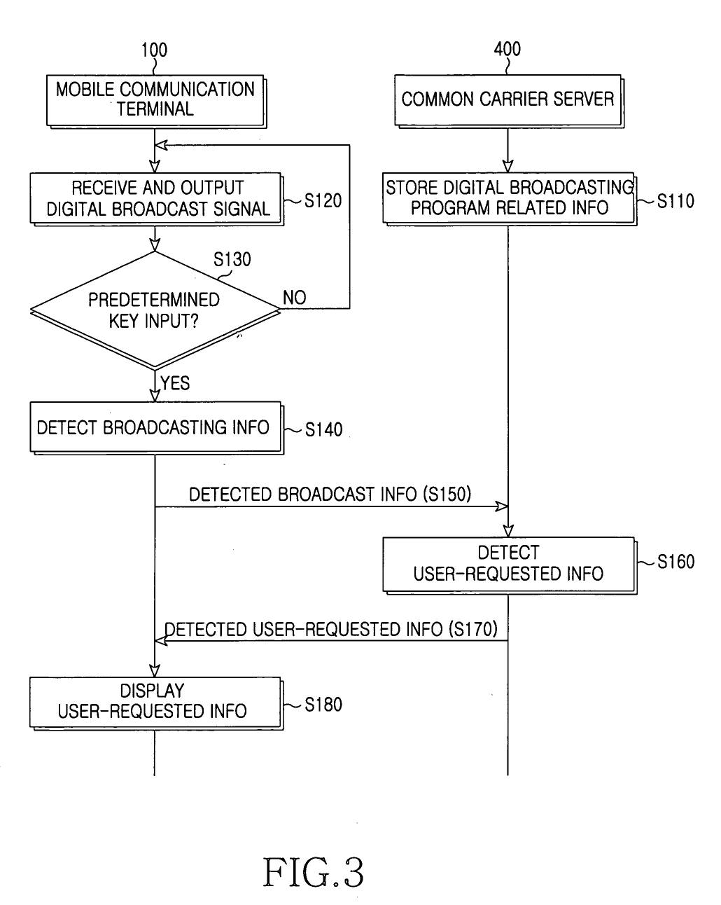

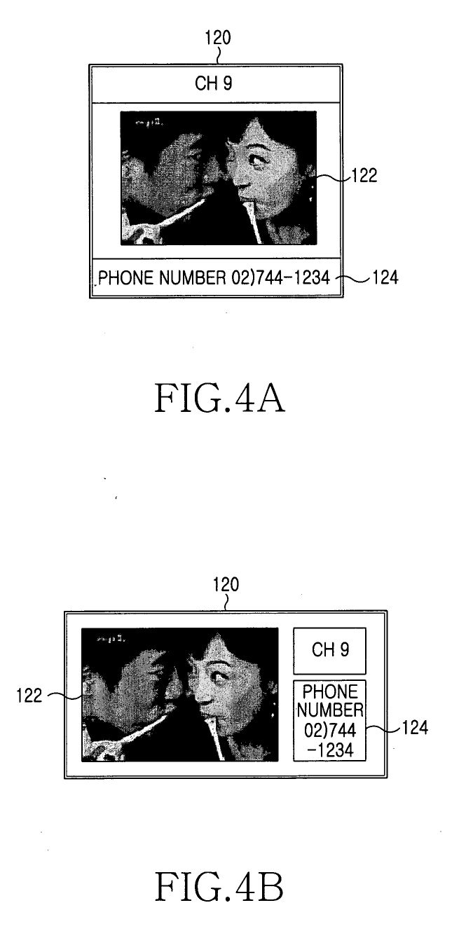

A detailed description will be made with reference to FIG. 3 and FIGS. 4A and 4B regarding a procedure in which the mobile communication terminal 100 receives user-requested information from the common carrier server 400 and provides a digital broadcasting service. FIG. 3 is a flowchart illustrating a procedure in which the mobile communication terminal 100, according to an embodiment of the present invention, receives user-requested information from the common carrier server 400 and provides a digital broadcasting service.

As illustrated in FIGS. 1 and 3, the common carrier server 400 stores digital broadcasting program related information for each of the programs of a digital broadcast signal, transmitted from the digital broadcasting center 200, and periodically updates the digital broadcasting program related information in step S110. At this time, the common carrier server 400 may receive the digital broadcasting program related information for each program of the digital broadcast signal through a separate device and periodically update the digital broadcasting program related information. Preferably, the digital broadcasting program related information for each program includes broadcasting information such as channel information and broadcasting time information of the digital broadcast signal. If the programs of the digital broadcast signal include a viewer-participating broadcasting program, it is preferable that the common carrier server 400 stores digital broadcasting program related information including a representative telephone number of a broadcasting station of the viewer-participating broadcasting program or a representative telephone number of the viewer-participating broadcasting program such as an ARS telephone number.

The controller 140 receives the digital broadcast signal transmitted from the digital broadcasting center 200 through the digital broadcasting receiver 150 and outputs the received digital broadcast signal through the display unit 120 and the audio processor 170 in step S120. The controller 140 determines if a predetermined key (e.g., a send key) for requesting user-requested information is input while outputting the received digital broadcast signal in step S130. The predetermined key may be separately provided in addition to the keys of the key input unit 110. Preferably, the user-requested information is one of a representative telephone number of a broadcasting station that transmits the received digital broadcast signal or a representative telephone number of a corresponding broadcasting program.

Upon input of the predetermined key, the controller 140 detects broadcasting information of the received broadcast signal from the digital broadcasting program guide data stored in the memory 130 in step S140. Herein, the broadcasting information may be channel information about a channel number of the received digital broadcast signal and broadcasting time information for a time zone in which the received digital broadcast signal is broadcast. Detecting the channel information and the broadcasting time information from the digital broadcasting program guide data is well known and will not be described herein.

The controller 140 transmits the detected broadcasting information to the common carrier server 400 through a data network in step S150. Upon receipt of the broadcasting information of the predetermined digital broadcasting program from the mobile communication terminal 100, the communication server 400 detects the user-requested information from the digital broadcasting program related information corresponding to the received broadcasting information in step S160.

The common carrier server 400 transmits the detected user-requested information to the mobile communication terminal 100 in step S170. It is preferable that the common carrier server 400 transmits the user-requested information to the mobile communication terminal 100 in the form of a short message or through wireless Internet.

Upon receipt of the user-requested information from the common carrier server 400, the controller 140 displays the received user-requested information on the display unit 120 in step S180. It is preferable that the controller 140 first stores the received user-requested information and outputs the received user-requested information along with the received digital broadcast signal using an OSD technique as shown in FIGS. 4A and 4B.

FIGS. 4A and 4B illustrate a method for providing a digital broadcasting service in a mobile communication terminal according to an embodiment of the present invention. FIG. 4A and 4B each provides a different example of how information may be output on the display unit 120. A screen 122 displays the video content of the broadcasting program. The broadcasting channel number and the representative telephone phone number for the broadcast program are displayed on screen 124. FIGS. 4A and 4B show different arrangements where channel 9 and the telephone number are displayed on the screen 124.

For example, when the screen 122 is a viewer-participating quiz program screen, if a user is not informed of a telephone number for participation, but desires to participate in the quiz program, the telephone number is received through the procedure shown in the flowchart of FIG. 3 and is output along with the channel number on screen 124 as illustrated in FIGS. 4A and 4B.

As described above, according to the present invention, when a user of a mobile communication terminal desires to participate in a digital broadcasting program while watching the broadcasting program, the user can participate in the broadcasting program by easily acquiring the necessary telephone contact information through input of a predetermined key. e. In addition, user convenience is improved by allowing the user of a mobile communication terminal to easily participate in a viewer-participating broadcasting program.

While a mobile communication terminal capable of receiving digital broadcasting is taken as an example and has been shown and described with reference to certain preferred embodiments thereof, it will be understood by those skilled in the art that the present invention is not limited to the mobile communication terminal, but various changes in form and details such as an electronic device capable of receiving digital broadcasting may be made therein without departing from the spirit and scope of the invention.

What is claimed is:

1. A method for providing a digital broadcasting service in a mobile communication terminal connected to a server that stores digital broadcasting program related information through a data network, the method comprising the steps of:
receiving a digital broadcast signal and outputting the received digital broadcast signal to a display unit;
transmitting broadcasting information of the received digital broadcast signal to the server upon input of a predetermined key for requesting user-requested information, while outputting the received digital broadcast signal to the display unit; and
receiving the user-requested information from the server and displaying the received user-requested information.

2. The method of claim 1, wherein the user-requested information is one of a telephone number of a broadcasting station that transmits the digital broadcast signal and a representative telephone number of a corresponding broadcasting program.

3. The method of claim 1, wherein the broadcasting information includes channel information and broadcasting time information of the received digital broadcast signal.

4. The method of claim 1, wherein the step of transmitting the broadcasting information comprises:
detecting the broadcasting information of the received digital broadcast signal from previously stored digital broadcasting information guide data upon input of the predetermined key for requesting the user-requested information, while outputting the received digital broadcast signal to the display unit; and transmitting the detected broadcasting information to the server.

5. The method of claim 4, wherein the predetermined key is a send key included in a keypad of the mobile communication terminal.

6. The method of claim 1, wherein the user-requested information is received in the form of a short message from the server.

7. The method of claim 1, wherein the user-requested information is received through the wireless Internet from the server.

8. The method of claim 1, wherein the step of displaying the received user-requested information comprises:
storing the user-requested information received from the server; and
displaying the stored user-requested information.

9. The method of claim 1, wherein the step of displaying the received user-requested information comprises displaying the user-requested information received from the server along with the received digital broadcast signal using an on-screen display (OSD) technique.
